(19) United States
(12) Patent Application Publication
(10) Pub. No.: US 2016/0329150 A1
(43) Pub. Date: Nov. 10, 2016

(54) Magnetic Wire Alignment Feeding Machine and Magnetic Alignment Feeding Method

(71) Applicant: MAGNEDESIGN CORPORATION, Aichi-ken (JP)

(72) Inventor: Yoshinobu HONKURA, Chita-gun (JP)

(73) Assignee: MAGNEDESIGN CORPORATION, Aichi-ken (JP)

(21) Appl. No.: 15/148,641

(22) Filed: May 6, 2016

(30) Foreign Application Priority Data
May 7, 2015 (JP) 2015-095129

(51) Int. Cl. H01F 41/096

(52) U.S. Cl. CPC H01F 41/096

(57) ABSTRACT

The present invention provides a magnetic wire alignment machine and its method to produce magnetic wire alignment on the substrate at the fine interval without twist stress. The magnetic wires can be allied along the groove on the substrate with the accuracy of ±1 μm by the very small interval by means of a precision feeding device which can adjust the parallel displacement between the wire as a basic line and the grove observed by a microscope. The magnetic wires cut under uniform tension are temporally fixed on the grooves on the substrate by the magnetic force and cured by the resin without twist stress.

### TECHNICAL FIELD

The present invention is related to a feeding machine and a feeding method to make multi magnetic wires alignment along grooves on a substrate without twisted stress.

### BACKGROUND ART

A super sensitive micro magnetic sensor called as MI sensor uses a micro magnetic amorphous wire with diameters of several decade micro meter as a sensitive body to a magnetic field and is widely used for electronics compass, medical devices, security sensors and so on. The MI element sensitive to magnetic field has amorphous wires sensitive to an outside magnetic field, detective coils surrounded around amorphous wires and four terminals for two coil terminals and two wire terminals on a substrate.

The magnetic wires have diameters from 10 μm to 30 μm and are put on the substrate with lower coil wirings. Patent Literature 1 disclosed how to fix the wires on the substrate. When the wires is fixed by ultrasonic joining method on the substrate under stress free condition, MI element gives a symmetry output against an external magnetic field because of almost no twist stress. However this method ultrasonic welded one by one is not practical in use because of its poor productivity.

Patent Literature 2 disclosed another method to fix the wires on the substrate. The wire is buried in a big groove with enough width and depth and fixed by adhesive resin keeping without twist stress and then the both ends of the wire is metal plated on the terminals of the substrate at the same time. This method has advantage to give good performance in productivity and symmetry sensor output but difficulty in making its coil pitch small.

Patent Literature 3 enclosed better method to fix the wires on the substrate directly without grooves. This method has advantage to increase productivity and make more fine pith coil easily but it has disadvantages to fall the wire unstable without slide constrain caused by the grooves accompanied with a lot of production troubles and to increase variation in coil characteristics. However it is difficult that this method makes a coil pitch within 30 μm because it needs thick resin films of 5 μm to 10 μm to fix the wire on the substrate.

At present MI sensor becomes popular and it is needed to make more improvements in sensitivity, micro size, measuring range and so on accompanied with its applications. The performance of MI sensor is dependent on factors of MI element such as the wire magnetic properties, the wire diameter, the coil turn numbers and the wire length. Some big challenges are made such as decrease of the magnetic wire diameter from 30 μm to and refinement in the coil pitch from 30 μm to 5 μm and in the coil inner diameter from 50 μm to 20 μm and increase of the wire numbers in one MI element are made.

Patent Literature 4 disclosed how to increase the measuring range of MI sensor, however the trade-off problem between the sensitivity and the measuring range is not solved. That is, the measuring range can be extended by decreasing the length of the magnetic wire to increase diamagnetic field but the sensitivity must be lowered by decreasing the coil turn numbers.

### CITATION LIST

### Patent Literature

[PTL 1]

### Japanese Unexamined Patent Application Publication No. 2000-81471

[PTL 2]

### WO2003/017299

[PTL 3]

### WO2012/043160A1

[PTL 4]

### JP Patent No. 5110142

### SUMMARY OF INVENTION

### Technical Problem

The problem to be solved is the trade-off relationship among the sensitivity, measuring range and micro size. One of solution to the trade-off problem must be to increase coil turn numbers by increasing numbers of the wire in a MI element and by refining both of the coil pitch and the inner coil diameter.

For refining the coil pitch, it is needed to decrease the height of the concave or convex structure from the substrate surface. If the half of the wire is embedded into a hallow groove, the height of the concave can be made a half. For refining the inner coil diameter, it is needed to decrease the width of the narrow groove from 50 μm to under 20 μm. For increasing numbers of the wire in a MI element, it is needed to decrease the coil size in the inner diameter and the coil pitch and to decrease the coil interval. It is needed that the wire is embedded into the narrow and hallow groove and aliened in a narrow interval line for increasing the coil turn numbers to keep the micro size.

However, current magnetic wire alignment feeding machines cannot make alignment with high precise so that it was difficult work to increase coil numbers of the wire in a MI element and to refine the coil pitch and the inner diameter cannot be realized. The invention challenges to develop a magnetic wire alignment feeding machine and the method with excellent precise for solving the trade-off problem between sensitivity, measuring range and micro size of MI sensor.

A current magnetic wire alignment feeding machine consists of a wire supply equipment comprising a wire bobbin, wire reels, a tension control device and a wire fixing entrance chuck(a) to draw the wire from the bobbin and fix it temporally, and a wire drawing equipment comprising a wire drawing chuck(b), a pressure bar to clamp the tensioned wire located between the chuck(a) and the chuck(b) before cutting, a substrate for wires to stand in line, a substrate clamped stage and a wire laser cutter and; a wire position controlling equipment comprising a base maker on the machine, a standard maker formed by a groove carved on the substrate, a detector to measure a slide displacement between the base maker and the standard marker, a precision feeding device for movable stage forward to X axis direction, Y axis direction, and Z axis direction, a magnetic field generator to fix the wire along to the standard line on the substrate and a substrate clamped stage built in the magnetic field generator set on the movable stage,

a control unit to keep a continuous wire alignment feeding operation in which the wire winded on the wire bobbin is extruded through wire reels and the chuck(a) to a designated position under a designated tension by the wire drawing chuck(b) and then the movable stage equipped the substrate with the standard marker moves to the designated position adjust to the basic marker using the precision feeding device and the wire is fixed on the big groove by the magnetic field generator to be cut by the wire laser cutter and then the moving stable goes down from the position and the next step of the operation is repeated continuously.

The parallel degree between the wire and the groove is controlled by the slide movement adjusting the displacement between the basic maker on the wire feeding equipment and the groove carved on the substrate fixed on movable stage. The machine cannot adjust the displacement between the wire and the wire feeding equipment and the rotated displacement so that it makes not so high parallel degree of 0.1 degree between the wire and the groove due to mechanical accuracy of the machine.

The purpose of the present invention is to invent a magnetic wire alignment feeding machine and the method which can make a magnetic wire alignment with high accuracy needed for producing MI element with the micro coil and multi wires and can produce the wire free from twisted stress.

The magnetic wire is sensitive to wire stress as well as the external magnetic field.

It is important that the wire has only uniform one way stress without twisted stress.

### Solution to Problem

The present inventor found that the conventional machine dependent on the machine assembly accuracy is unavoidable in meeting the limitation of the accuracy of 0.05 degree and of its slide displacement of ±5 The present inventor thought of an idea that if the parallel displacement between the wire and the groove on the substrate is measured directly by a microscope and is adjusted by the precision feeding device equipped with slide movement, elevated movement and rotation, it can be easily achieved with the high accuracy of under ±0.02 degree and with its slide displacement of under ±1 μm.

In other words, the present inventor found a new idea that the wire drawn by the wire drawing chuck (b) from the bobbin with a designated tension is recognized as a basic line and the groove on the substrate with the width a little wider than the wire diameter is recognized as a standard line. The parallel displacement between the basic line and the standard line is measured by the microscope set right over the substrate, it can be adjusted easily by the precision feeding device with rotation as well as slide movement. By the way, the standard line can be formed not only a groove but also a post array or a line marker on the substrate.

The main purpose of the present invention is to produce a micro size MI element so that the invention is explained using concrete dimensions of the main factors of the machine to put it plainly. The validity of the present invention is not limited by the dimension used for explain.

The precision feeding device for the movable stage with the accuracy of under ±1 μm has the slide feed mechanism vertical to the wire direction and the elevated feed mechanism. The slide mechanism can adjust the slide displacement between the basic line defined by the wire and the standard line defined by the groove on the substrate within the accuracy of ±1 μm. The rotation mechanism can adjust the parallel displacement between the basic line and the standard within the accuracy of ±0.02 degree. As a result, the wire of the 10 μm diameter is set on the groove with 20 μm width on the substrate of 6 inch.

The elevated mechanism moves the stage close to the wire by under 1 μm in order to measure the displacement between the wire and the groove by the microscope with resolution of 1 μm and after adjusting the parallel displacement, it elevates the stage by 7 μm corresponding to the groove depth so that the wire can be embedded into the groove.

It is necessary that the precision feeding device for the movable stage prepare a control ability to put the wire into the groove. The enough control ability is kept in conditions that the groove width is controlled with the range of 1.2 to 3 times wider, the groove depth is controlled with the range of 0.5 to 1.2 times deeper and the accuracy is controlled with under 0.2 times smaller compared to the wire diameter.

The present invention should be not limited within the above mentioned numerical relationship but the numerical range should be desirable for its application to produce a micro size MI element.

The slide feeding mechanism can control three different feeding intervals of the wire slide defined according to a wire interval in a coil, a coil interval with built-in wires and an element interval with some coils.

The wire interval in a coil is practically used from the minimum defined by wire diameter to maximum about 20 μm. The coil interval with built-in wires is practically used from 50 μm to 100 μm. The element interval with some coils from 200 μm to 400 μm. The slide feeding mechanism is needed to have the slide movement distance of 200 mm with the slide accuracy of ±1 μm.

By the way, in the case to supply multi wires at the same time, the slide movement distance of the slide feeding mechanism is given by dividing 200 mm by number of wires.

The magnetic wire without twisted stress is produced in the process wherein a wire is drawn with a uniform internal stress of a designated enough strength and fixed by the chuck(b) and the chuck(c). After the precision feeding device control the stage to put the wire into the groove the wire is fixed on the groove by the magnetic field generator and then the wire is cut by the wire cutter at the position between the chuck(a) and the chuck(c) subsequently both chuck are open to make the wire stress free and the wire is kept in the groove by the magnetic force. The magnetic wire of this situation is perfect free from inner stress and twist stress and is fixed on the substrate using an adhesive resin keeping without twisted stress.

The method to fix the wire on the substrate is not limited to the above mentioned method as long as all wires fix on the substrate without twist stress.

The magnetic field generator is designed on how to generate the magnetic force in consideration of the thickness of the substrate and the interval between the wire and the top of the magnet.

It consists of a combined magnet, a magnetic yoke and a nonmagnetic thin film placed on the top of the magnetic field generator for protection. The combined magnet is produced by some rectangular parallelepiped magnets with 3 mm thickness which line up vertical to the wire line in a row with magnetization of north-pole and south-pole alternately

This magnetic field generator is placed on the movable stage. The substrate is placed on the magnetic field generator and clamped to the stage. The magnetic wire without twist stress after cutting is kept in the groove of the substrate by the magnetic force given from the magnetic field generator.

The magnetic field generator of the present invention is not limited to the above mentioned one. It is allowed as long as it can generate an enough magnetic force to fix the wire. As example an electromagnet can be used as the magnetic field generator.

The wire cutter of the present invention is not limited to the mechanical type cutter and any method including a laser cutter is applicable as the wire cutter of the present invention as long as it can cut the wire without twist stress.

### Effect of Invention

The present invention gives the effect to produce a micro size MI element base on a new machine to make magnetic wire alignment with high accuracy wherein the wire is drawn with a designated tension recognized as a basic line and the groove on the substrate is recognized as a standard line. The parallel displacement between the basic line and the standard line is measured by the microscope set right over the substrate, it can be adjusted easily by under ±0.02 degree with the movable stage controlled by the precision feeding device.

Moreover, the present invention gives the effect to improve both properties of the sensitivity and the measuring range by achieving multi wire alignment with very small interval in one MI element.

By the way, the present invention is not limited to MI sensor. It can be applied to the magnetic sensors such as FG sensor and GSR sensor which consist of the magnetic wire and the coil surrounding the wire.

### BRIEF DESCRIPTION OF DRAWINGS

FIG. 1 is a schematic view of a magnetic wire alignment feeding machine of the present invention.

FIG. 2 is a schematic view of the magnetic field generator to fix the magnetic wire by the magnetic force.

FIG. 3 is a schematic view of the position for MI element and the magnetic wire on the substrate.

### DESCRIPTION OF EMBODIMENTS

### First Embodiment

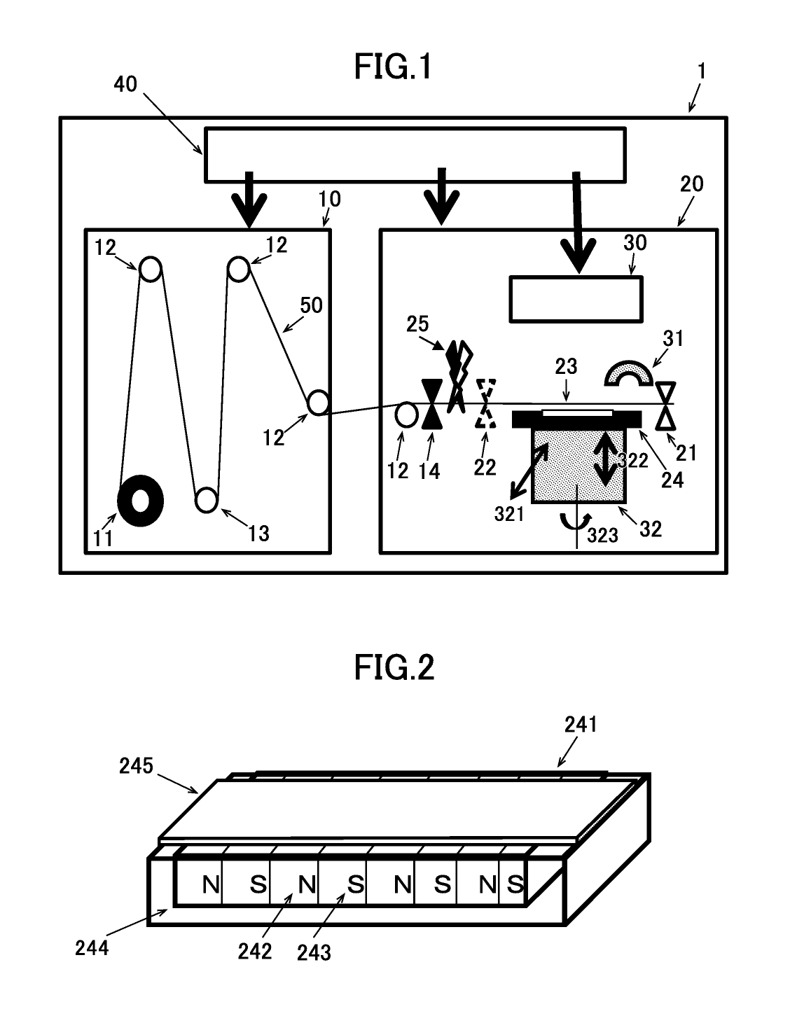

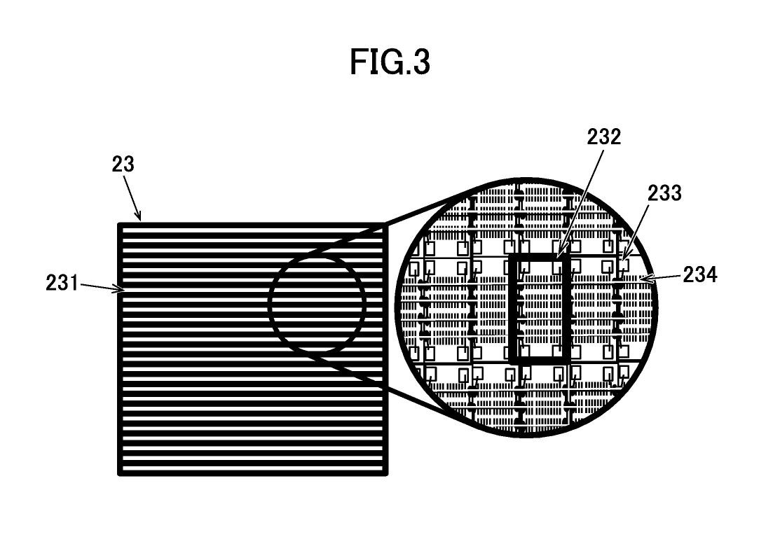

The first embodiment of the present invention on a magnetic wire alignment feeding machine using the magnetic wire as a basic line is explained as bellow using FIG. 1.

A magnetic wire alignment feeding machine 1 comprise a wire supply equipment 10 comprising a wire bobbin 11, wire reels 12, a tension control device 13 and a wire fixing entrance chuck(a) 14 and;

a wire alignment feeding equipment 20 comprising a wire drawing chuck(b) 21, a wire temporary fixing chuck(c) 22 to clamp the tensioned wire located between the chuck(a) and the chuck(b) before cutting, a substrate 23 for wires to stand in line, a substrate clamped stage 24 and a wire cutter 25 and;
a wire position controlling equipment 30 comprising a base line decided by a drawn wire 50, a standard line decided by grooves 231 carved on the substrate 23, a microscope 31 to measure a displacement between the base line and the standard groove 231, a precision feeding device 32 for movable stage 24 equipping the slide feed mechanism 321, the lift mechanism 322 and the rotation mechanism 323, a combined magnet 241 to fix the magnetic wire 50 along to the grooves 231 on the substrate and a substrate clamped on the movable stage,
and a control unit 40 to keep a continuous wire alignment feeding operation in which the wire 50 winded on the wire bobbin 11 is extruded through wire reels 12 and the chuck(a) 14 to a designated position under a designated tension by the wire drawing chuck(b) 21 and the chuck(c) 22 and then the movable stage 24 equipped the substrate 23 with the standard line moves to the designated position adjust to the basic line using the precision feeding device and the wire is fixed on the groove by the combined magnet 241 to be cut by the wire cutter 25 and then the moving stable goes down from the position and the next step of the operation is repeated continuously.
where a wire with a uniform internal stress under the state fixed by the chuck(b) and the chuck(c) is cut by the wire cutter at the position between the chuck(a) and the chuck(c) and then is put along to the standard line on the substrate by the magnetic force without twisted stress.

The magnetic wire is aliened along the grooves using the above machine in the process where the wire is drawn using the wire drawing chuck(b) 21 with the designated tension from the wire supply equipment 10 and is fixed at the designated place using the chuck(a) (b) and (c). Subsequently the parallel displacement between the wire and the groove on the substrate is measured using the microscope 31 and then both lines is in keeping with parallel by moving the substrate using the precision feeding device 32.

A desirable magnetic wire is the magnetic amorphous wire coated by a glass with the diameter of 10 μm to 20 μm.

A desirable substrate is a silicon substrate having grooves and MI elements wiring over the whole face. The grooves are formed with the width of 15 μm to 30 μm and the depth of 5 μm to 15 μm and with the element interval of 100 μm to 300 μm. The lower coil wiring of MI element and the terminal wiring are imprinted on the substrate with the grooves.

It is noted that the substrate is put on the movable stage to keep the direction of grooves orthogonal to the direction of the slide feed mechanism.

The tension control device 13 in the wire supply equipment 10 can control the load of 1 g to 20 g and the wire tension for the wire of the 10 μm diameter is suitable in control range of 10 to 100 Kg/mm².

The movable stage 24 consists of the combined magnet 241 to fix the wire 50 into the grooves as the standard line, the substrate 23 and a holder to cramp the substrate 23 on the magnet.

The precision feeding device 32 for movable stage 24 equips the slide feed mechanism 321 with the movable capacity over the width of the substrate, the lift mechanism 322 with the movable capacity of maximum 20 mm with the accuracy of under ±1 μm and the rotation mechanism 323 with the rotation capacity of under 180 degree with the accuracy of under ±0.01 degree and the feeding operation using the precision feeding device 32 is controlled by the control unit 40.

The structure of the magnetic field generator installed on the movable stage is shown in FIG. 2. The magnetic field generator is designed on how to generate the magnetic force in consideration of the thickness of the substrate and the interval between the wire and the top of the magnet.

The magnetic field generator consists of a combined magnet, a magnetic yoke 244 assembled with the combined magnet and a nonmagnetic thin film 245 placed on the top of the magnetic field generator for protection. The combined magnet is produced by some rectangular parallelepiped magnets with 3 mm thickness which line up vertical to the wire line in a row with magnetization of north-pole 242 and south-pole 243 alternately.

This magnetic field generator 24 is placed on the movable stage. The substrate 23 is placed on the magnetic field generator 24 and clamped to the stage. The magnetic wire without twist stress after cutting is kept in the groove of the substrate by the magnetic force given from the magnetic field generator 24.

The microscope 31 measures the parallel displacement between the basic line of the wire and the standard line of the groove before the wire 50 is made alignment in the groove on the substrate 23. The stage is feed by the precision feeding device 32 to make the slide displacement within ±1 μm and the rotation displacement within ±0.02 degree using the slide feed mechanism 321 and the rotation mechanism 323.

After adjusting the parallel degree, the substrate 23 is lifted up to contact the wire 50 to the bottom of the groove 231 using the lift mechanism 322. Finally the parallel degree between the wire and the groove is observed by the microscope 31 and the feed values are memorized in the control unit 40 as the initial set values.

After that, the wire 50 is cut by the wire cutter between the chuck (a) 14 and the chuck(c) 22 following the chuck (b) 21 and the chuck (c) 22 are open so that the wire 50 is free from the inner stress including twist stress. After both chucks are open, the wire is fixed on the groove by the magnetic force given by the magnetic field generator.

A desirable microscope 31 is requested to have the high resolution of ±1 μm and deep focus depth because the wire and the groove on the substrate are placed not on the same plane. The detector to measure the displacement between the wire and the groove is not limited to microscopes. It is available as long as it can measure the displacement.

The magnetic wire alignment feeding machine according to any claim from the claim 1 to the claim 4, wherein the magnetic wire alignment feeding machine mentioned above can

The wire supply equipment 10 for mass production is improved to multiple wire supply type which can supply multi wires 50 at the same time. At the case the press cutter or the laser cutter to give good productivity can be used in spite of high price. By the way, the desirable reel is the type to have V groove to keep the wire in the reel strongly.

The control unit 40 has;

1) the functionality adjusting the tension of the wire, the pressure of the chuck (a), (b) and (c), and the power of the wire cutter automatically according to the wire diameter, glass thickness and wire magnetic properties.
2) the automatic reset functionality on the initial origin of the movable stage, and the working standard position.
3) the functionality adjusting the position of the movable stage to keep parallel between the wire and the groove automatically based on the measuring data on the parallel displacement between the wire and the groove by the microscope.
4) the program to manage the situation of the operation using the parameters such as the thickness of the substrate, the depth of the groove, and the wire diameter.

By the way, the control unit has a manual operation mode used at an emergency.

### Second Embodiment

The second embodiment of the present invention is related to the method on producing a magnetic wire free form twist using the first embodiment of the present invention.

The magnetic wire is aliened along the grooves using the first embodiment of the present invention in the process where the wire is drawn using the wire drawing chuck(b) 21 with the designated tension from the wire supply equipment 10 and is fixed at the designated place using the chuck(a) (b) and (c). Subsequently the parallel displacement between the wire and the groove on the substrate is measured using the microscope 31 and then both lines is in keeping with parallel by moving the substrate using the precision feeding device 32.

After the precision feeding device control the stage to put the wire into the groove the wire is fixed on the groove by the magnetic field generator and then the wire is cut by the wire cutter at the position between the chuck(a) and the chuck(c) subsequently both chuck are open to make the wire stress free and the wire is kept in the groove by the magnetic force. The magnetic wire of this situation is perfect free from inner stress and twist stress and is fixed on the substrate using an adhesive resin keeping without twisted stress.

The tension control device 13 in the wire supply equipment 10 can control the load of 1 g to 20 g and the wire tension of 10 to 100 Kg/mm². For removing the inner stress of the wire, it is effective that the wire is cut under the wire tension of over 50 Kg/mm². However the tension of over 100 Kg/mm² is apt to cause the fracture so that it is kept under 100 Kg/mm².

This magnetic field generator must produce the strong magnetic force enough to keep the wire in the groove before it is fixed by the adhesive resin. However it is clamped to the stage and feed by the precision feeding device so that it should be deigned to be light and small because it is difficult a heavy stage feeds with high accuracy.

The magnetic wire of this situation is perfect free from inner stress and twist stress and is fixed on the substrate using an adhesive resin keeping without twisted stress. It is necessary that the adhesive resin is coated over the whole face of the substrate including the top of the wire so that it needs to have suitable viscosity. An adhesive resin with low viscosity is easy to penetrate into the gap between the wire and the groove but is hard to climb up the top of the wire. On the other hand, an adhesive resin with high viscosity is easy to climb up the top of the wire but large thickness of the resin on the wire is not desirable to make difficult in producing the micro coil and is hard to penetrate into the gap between the wire and the groove. It is concluded that a suitable viscosity is important.

### Third Embodiment

The third embodiment of the present invention is related to the method on making alignment of multi magnetic wires in one MI element. The method is given as a program installed into the control unit.

The groves are formed over the whole face of the substrate by the numbers of the wires in one MI element with a unit of the interval of MI element. The smaller size is desirable but it is needed to have larger width of 10 μm to 30 μm than the wire diameter of 6 μm to 20 μm and similar size to the wire radius of 3 μm to 10 μm.

The numbers of the wires in one element are suitable from 1 to 10. The micro size of MI element can be achieved by the means of small groove interval. The wires in one coil are aliened into the grooves with the width a little larger than the diameter of the magnetic. The groove interval designated by coil interval is suitable from 30 μm to 100 μm in order to keep insulation between next coil wirings.

The current MI element has the length of 0.6 mm and the width of 0.4 mm with the coil turns of 16. The micro sized MI element produced using the magnetic wire alignment feeding machine given by the present invention has the length of 0.2 mm and the width of 0.4 mm to set 4 wires of the interval of 50 μm in one MI element and it takes the coil turns of 100 which improve 6 times larger output voltage than the current one.

When 2 wires is inserted into one coil, the numbers of wires becomes 8 so that the output voltage becomes 2 times larger than one of 1 wire type. Another advantage by the decrease of the MI element length from 0.6 mm to 0.2 mm can improve in the measuring range from 12G to 60G.

In addition, the wire is fixed in the shallow groove with the depth of half of the wire diameter resulting that the unevenness becomes half. In general, the width of the wiring produced by photolithography is in inverse proportion against the square of the unevenness. The micro coil with 4 times finer coil pitch must be produced using the present invention and the sensitivity of MI sensor increases 4 times better.

### EXAMPLES

### Example 1

A magnetic wire alignment feeding machine produced as the first example according to the first embodiment of the present invention is explained using FIG. 1 and FIG. 2.

The first embodiment of the present invention on a magnetic wire alignment feeding machine using the magnetic wire as a basic line is explained as bellow using FIG. 1.

A magnetic wire alignment feeding machine 1 comprised a wire supply equipment 10 comprising a wire bobbin 11, wire reels 12, a tension control device 13 and a wire fixing entrance chuck(a) 14 and;

a wire alignment feeding equipment 20 comprising a wire drawing chuck(b) 21, a wire temporary fixing chuck(c) 22 to clamp the tensioned wire located between the chuck(a) and the chuck(b) before cutting, a substrate 23 for wires to stand in line, a substrate clamped stage 24 and a wire cutter 25 and;
a wire position controlling equipment 30 comprising a base line decided by a drawn wire 50, a standard line decided by grooves 231 carved on the substrate 23, a microscope 31 to measure a displacement between the base line and the standard groove 231, a precision feeding device 32 for movable stage 24 equipping the slide feed mechanism 321, the lift mechanism 322 and the rotation mechanism 323, a combined magnet 241 to fix the magnetic wire 50 along to the grooves 231 on the and a substrate clamped on the movable stage, and a control unit 40 to keep a continuous wire alignment feeding operation in which the wire 50 winded on the wire bobbin 11 is extruded through wire reels 12 and the chuck(a) 14 to a designated position under a designated tension by the wire drawing chuck(b) 2l and the chuck(c) 22 and then the movable stage 24 equipped the substrate 23 with the standard line moves to the designated position adjust to the basic line using the precision feeding device and the wire is fixed on the groove by the combined magnet 241 to be cut by the wire cutter 25 and then the moving stable goes down from the position and the next step of the operation is repeated continuously.

The magnetic wire was aliened along the grooves using the above machine in the process where the wire was drawn using the wire drawing chuck(b) 21 with the designated tension from the wire supply equipment 10 and was fixed at the designated place using the chuck(a) (b) and (c). Subsequently the parallel displacement between the wire and the groove on the substrate 23 was measured using the microscope 31 and then both lines is in keeping with parallel by moving the substrate by the slide feed mechanism 321, the lift mechanism 322 and the rotation mechanism 323 in the precision feeding device 32.

A magnetic amorphous wire 50 coated by a glass of the 1 μm thickness with the diameter of 12 μm to 20 μm was used.

A silicon substrate with the square of 100 mm by 100 mm was used.

The grooves with the width of 20 μm and the depth of 8 μm and with the element interval of 200 μm were formed over the whole face.

The lower coil wiring of MI element and the terminal wiring were imprinted on the substrate 23 with the grooves.

The substrate 23 was put on the movable stage 24 to keep the direction of grooves orthogonal to the direction of the slide feed mechanism with the error of 0.003 degree.

The tension control device 13 in the wire supply equipment 10 loaded 6 g and the wire tension of 76 Kg/mm² for the wire of the 10 μm diameter was applied.

The microscope 31 measured the parallel displacement between the basic line of the wire and the standard line of the groove before the wire 50 was made alignment in the groove on the substrate 23. The stage was feed by the precision feeding device 32 to make the slide displacement with the accuracy of ±1 μm and the rotation displacement with the accuracy of ±0.01 degree using the slide feed mechanism 321 and the rotation mechanism 323.

After adjusting the parallel degree, the substrate 23 was lifted up to contact the wire 50 to the bottom of the groove 231 using the lift mechanism 322.

Finally the parallel degree between the wire and the groove was observed by the microscope 31 and the feed values were memorized in the control unit 40 as the initial set values.

After that, the wire 50 was cut by the wire cutter between the chuck (a) 14 and the chuck(c) 22 following the chuck (b) 21 and the chuck (c) 22 were open so that the wire 50 was free from the inner stress including twist stress. After both chucks were open, the wire was fixed on the groove by the magnetic force given by the magnetic field generator 24.

A microscope 31 with the high resolution of ±1 μm was used. It was fixed on the body of the magnetic wire alignment feeding machine strongly to protect it from vibration. The focus of the microscope 31 was controlled by a control dial at hand. The precision feeding device 32 for movable stage 24 equipped the slide feed mechanism 321 with the movable capacity of 100 mm, the lift mechanism 322 with the movable capacity of 20 mm with the accuracy of ±1 μm and the rotation mechanism 323 with the rotation capacity of under 180 degree with the accuracy of ±0.01 degree and the feeding operation using the precision feeding device 32 was controlled by the control unit 40.

The structure of the magnetic field generator installed on the movable stage is shown in FIG. 2. The magnetic field generator consisted of a combined magnet, a magnetic yoke 244 assembled with the combined magnet and a nonmagnetic thin film 245 placed on the top of the magnetic field generator for protection.

The combined magnet was assembled by 20 pieces of rectangular shaped magnets with 120 mm length, 5 mm width and 3 mm thickness, which lined up vertical to the wire line in a row with north-pole magnetized magnets 242 and south-pole magnetized magnets 243 alternately. This magnetic field generator 24 was placed on the movable stage. The substrate 23 was placed on the magnetic field generator 24 and clamped to the stage. The magnetic wire without twist stress after cutting was kept in the groove of the substrate by the magnetic force given from the magnetic field generator 24.

By the way, the wire reel 12 having V groove was used and the mechanical type of the wire cutter 25 was used.

The control unit 40 prepared;

1) the functionality adjusting the tension of the wire, the pressure of the chuck (a), (b) and (c), and the power of the wire cutter automatically according to the wire diameter, glass thickness and wire magnetic properties.
2) the automatic reset functionality on the initial origin of the movable stage, and the working standard position.
3) the functionality adjusting the position of the movable stage to keep parallel between the wire and the groove automatically based on the measuring data on the parallel displacement between the wire and the groove by the microscope.
4) the program to manage the situation of the operation using the parameters such as the thickness of the substrate, the depth of the groove, and the wire diameter.

By the way, the control unit could make a manual operation mode at an emergency.

The continuous operation of the magnetic wire alignment feeding machine was carried out and confirmed that the wire alignment could be achieved over the whole face of the substrate, wherein a wire drawing, fixing both ends of the wire, lifting the stage to the adjusting position, fixing the wire in the groove by magnetic force temporally, cutting wire, turning down the stage and feeding the stage were made by turn continuously.

The result above made clear that the present example can make the wire alignment over the whole face with the fine interval and produce the micro size type of the MI element, which means the present example gives remarkable worthy to industry.

### Example 2

The second example of the present invention is related to the method on producing a magnetic wire free form twist using the first example of the present invention.

The tension control device 13 in the wire supply equipment 10 loaded 6 g and the wire tension of 76 Kg/mm² for the wire 50 of the 10 μm diameter and the glass coating thickness of 1 μm was applied.

On the condition that the big tension make the inner stress uniform by fixing the both ends of the wire with the chuck (a)m(b) and (c), the magnetic wire was cut subsequently the chucks were open and then the magnetic wire 50 were fixed temporally by the magnetic force generated by the magnetic field generator 24. The stage 24 with the wire aliened substrate was carried to next process where the wires were fixed in the grooves by adhesive resin over the whole face of the substrate to make MI element without twist stress. The test on MI sensor output against the external magnetic field resulted that it was symmetric and found out the wires were free from twist stress. If the wire has twist stress, test result was not symmetric. The wires were fixed by curing after the resin dropped and coated over the whole face of the substrate.

### Example 3

The third example of the present invention is related to the method on making alignment of 8 magnetic wires in one MI element using same machine, same magnetic wire and same substrate used for the first example and the second example of the present invention.

The method characterized by the slide interval with three deferent intervals such as the element interval, coil interval between unit coils and wire interval in the one coil was given as a program installed into the control unit.

The numbers of the wires in one element are suitable from 1 to 10. The micro size of MI element can be achieved by the means of small groove interval. The wires in one coil are aliened into the grooves with the width a little larger than the diameter of the magnetic. The groove interval designated by coil interval is suitable from 30 μm to 100 μm in order to keep insulation between next coil wirings.

The grooves 231 on the substrate 23 were formed by 2400 rows. The row of elements on the substrate 23 were formed by 300 rows with the interval of 300 the row of coils were formed by 4 rows and the row of wire in the coil were formed by 2 rows. The coil had the width of 55 μm gap between coils and the coil interval of 60 μm. The 2 grooves in one coil were formed with the width of 15 μm and the 5 μm gap between grooves. The groove was 15 μm in width and 8 μm in depth. After forming the grooves, the coil wiring and terminals wirings were imprinted on the substrate.

As for the slide feed program of the movable stage, the method adjusting parallel between the wire and the groove was carried out in the same procedure to the first example. But the slide feed method was changed to feed the stage by three different intervals such as 20 μm for wire interval inside one coil, 60 μm for the coil interval and 300 μm for the element interval.

The current MI element had the length of 0.6 mm and the width of 0.4 mm with the coil turns of 16. The micro sized MI element of the third example had the length of 0.2 mm and the width of 0.3 mm. The MI element size of the third example became ¼ smaller than that of the current MI element.

The decrease of the MI element length from 0.6 mm to 0.2 mm improved in the measuring range from 12 G to 60 G. At the same time the sensitivity increased 5 times proportional to the coil turn numbers.

The above examples were applied only to MI element but the machine and the method of the present invention is applicable to produce FG sensor element and GSR sensor element which consists of the magnetic wire and the coil binding around the wire.

### INDUSTRIAL APPLICABILITY

As mentioned above, the magnetic wire alignment machine and the method of the present invention to make wire alignment make remarkable contributions in producing the micro size MI element. It is also expected in producing FG sensor element and GSR sensor element.

### REFERENCE SIGNS LIST

1: A magnetic wire alignment feeding machine
10: a wire supply equipment
11: wire bobbin
12: wire reels
13: a tension control device
14: a wire fixing entrance chuck(a)
20: a wire alignment feeding equipment
21: a wire drawing chuck(b)
22: a wire temporary fixing chuck(c)
23: a substrate for wires to stand in line
231: grooves
232: unit elements
233: substrate terminals
234: lower wirings on a substrate
235: a substrate clamped stage
24: a magnetic field generator
241: a combined magnet
242: north-pole magnetized magnets
243: south-pole magnetized magnets
244: magnetic yoke
245: nonmagnetic thin film
25: a wire cutter
30: a wire position controlling equipment
31: a microscope
32: a precision feeding device for movable stage
321: a slide feed mechanism
322: a lift mechanism
323: a rotation mechanism
40: a control unit
50: a magnetic wire

1. A magnetic wire alignment feeding machine, comprising:
a wire supply equipment comprising a wire bobbin, wire reels, a tension control device and a wire fixing entrance chuck(a) and;
a wire alignment feeding equipment comprising a wire drawing chuck(b), a wire temporary fixing chuck(c) to clamp the tensioned wire placed between the chuck(a) and the chuck(b) before cutting, a substrate for wires to stand in line, a substrate clamped stage and a wire cutter and;
a wire position controlling equipment comprising a base line decided by a drawn wire, a standard line carved on the substrate, a detector to measure a parallel displacement between the base line and the standard groove, a precision feeding device for movable stage equipping a slide feed mechanism, a lift mechanism and a rotation mechanism, a magnetic field generator to fix the wire along to the standard line on the substrate and a substrate clamped plate built in the magnetic field generator set on the movable stage, a control unit to keep a continuous wire alignment feeding operation in which the wire winded on the wire bobbin is drawn through wire reels to the chuck(a) at a designated position under a designated tension by the wire drawing chuck(b) and the chuck(c) and then the movable stage equipped the substrate with the standard line moves to the designated position adjust to the basic line using the precision feeding device and the wire is fixed on the groove by the magnetic field generator following to be cut by the wire cutter and then the moving stable goes down from the position and the next step of the operation is repeated continuously, wherein a wire with a uniform internal stress under the state fixed by the chuck(b) and the chuck(c) is cut by the wire cutter at the position between the chuck(a) and the chuck(c) and then is put along to the standard line on the substrate by the magnetic force without twisted stress.

2. The magnetic wire alignment feeding machine according to claim 1, wherein the magnetic field generator consists of a combined magnet produced by some rectangular parallelepiped magnets which line up vertical to the wire line in a row with north-pole magnetized magnets and south-pole magnetized magnets alternately and a magnetic yoke.

3. The magnetic wire alignment feeding machine according to claim 1, wherein the standard line is formed as a groove to make constraint against side slip of the wire.

4. The magnetic wire alignment feeding machine according to claim 1, wherein a mechanical cutter is used as the wire cutter.

5. The magnetic wire alignment feeding machine according to claim 1, wherein the magnetic wire alignment feeding machine mentioned above can supply multi wires at the same time.

6. The magnetic wire alignment feeding machine according to claim 1, wherein the control unit can control three different intervals of the wire slide defined according to a wire interval in a coil, a coil interval with built-in wires and an element interval with some coils.

7. The magnetic wire alignment feeding method using the magnetic wire alignment feeding machine defined according to claim 1, wherein a following step fixes the wires on the substrate using an adhesive resign keeping without twisted stress.
